(19) United States
(12) Patent Application Publication
(10) Pub. No.: US 2020/0311827 A1
(43) Pub. Date: Oct. 1, 2020

(54) CROWDSOURCING AND CROWDFUNDING PLATFORM

(71) Applicant: COMMISSIONED LLC, Kansas City, MO (US)

(72) Inventors: James KRAMER, Kansas City, MO (US); Anna NOWAKOWSKI, Kansas City, MO (US)

(21) Appl. No.: 16/834,737

(22) Filed: Mar. 30, 2020

Related U.S. Application Data
(60) Provisional application No. 62/826,152, filed on Mar. 29, 2019.

(51) Int. Cl. G06Q 50/00; G06F 16/9536; G06Q 30/02; G06Q 10/06; G06Q 20/10

(52) U.S. Cl. CPC G06Q 50/01; G06F 16/9536; G06Q 20/108; G06Q 10/06315; G06Q 30/0279; G06Q 30/0204

(57) ABSTRACT

A crowdsourcing platform can include a user registry module to allow users to create accounts with the platform, the account including information pertaining to resources and needs. The platform can also include a group module to allow users to create groups and corresponding group codes. The platform can also include a matching module to match users with groups based on identified resources and needs. The platform can also include a mobilization module to allow matched users to publish the identified need to each of the matched user's groups.

### CROSS REFERENCE TO RELATED APPLICATIONS

This application claims priority to and the benefit of U.S. Provisional Patent Application No. 62/826,152, titled “SAAS & PAAS CROWDSOURCING AND CROWDFUNDING PLATFORM” and filed on Mar. 29, 2019, which is hereby incorporated herein in its entirety.

### BACKGROUND

Historically, there have been no mechanisms for Christians to know what other Christians are doing or have done successfully. Indeed, a unified Christian communication technology platform does not currently exist. As a result, Christians end up constantly recreating the wheel, wasting time, energy, and resources in overlapping efforts. This results in the unfortunate situation where Christians end up competing against each other instead of collaborating. Frequently, there is non-unified strategic leadership, limited resource sharing, and a lack of clear and common finish lines.

Popular social media platforms frequently and blatantly censor Christian organizations and causes, and some have completely banned Christian groups from using their platforms altogether. Alternative Christian technology options are mostly nonexistent and those that do exist are inadequate for effective mobilization efforts. There is a real chance that, before long, Christians may be blacklisted from current digital platforms, thus impacting their businesses, ministries, and personal lives.

There are more than 120 million church goers and over 50 million “Bible believing” Christians in the United States. 84% of churches regularly use social media to communicate with their congregations and over 70% of faith-based non-profits consider it to be their most important communication tool. Thus, there is a unique and immediate opportunity for a robust Christian technology platform to become the go-to application for Christians to connect, communicate, and collaborate.

Further, traditional philanthropic efforts have had various types of problems and risks associated therewith. For example, they can be costly as there are typically transaction fees, administrative expenses, operating expenses. Such efforts also historically have a great amount of risk and potential exposure to fraud and misuse. Opportunities to give have usually been limited and it is often difficult—if not impossible—to determine an accurate return on investment.

Additionally, a fragmented supply chain is typically fraught with issues such as ineffective recruitment and deployment, a lack of best practices and standards, fragmented and/or siloed communication, underfunded initiatives, a lack of comprehensive planning or strategy, and undefined mission outcomes.

Accordingly, there remains a need for a way to address these and other deficiencies associated with the prior art.

### BRIEF DESCRIPTION OF THE DRAWINGS

FIG. 1 is a screenshot illustrating an example of a register/login interface in accordance with certain implementations of the disclosed technology.

FIG. 2 is a screenshot illustrating an example of a group code entry interface in accordance with certain implementations of the disclosed technology.

FIG. 3 is a screenshot illustrating an example of an email address and password entry interface in accordance with certain implementations of the disclosed technology.

FIG. 4 is a screenshot illustrating an example of a sphere of interest entry interface in accordance with certain implementations of the disclosed technology.

FIG. 5 is a screenshot illustrating an example of a user photo interface in accordance with certain implementations of the disclosed technology.

FIG. 6 is a screenshot illustrating an example of an organization selection interface in accordance with certain implementations of the disclosed technology.

FIG. 7 is a screenshot illustrating an example of a first extended profile entry interface in accordance with certain implementations of the disclosed technology.

FIG. 8 is a screenshot illustrating an example of a sphere identification interface in accordance with certain implementations of the disclosed technology.

FIG. 9 is a screenshot illustrating an example of a ministry giftings identification interface in accordance with certain implementations of the disclosed technology.

FIG. 10 is a screenshot illustrating an example of a second extended profile entry interface in accordance with certain implementations of the disclosed technology.

FIG. 11 is a screenshot illustrating an example of a signup confirmation interface in accordance with certain implementations of the disclosed technology.

FIG. 12A is a screenshot illustrating an example of a first view of a personalized content feed interface in accordance with certain implementations of the disclosed technology.

FIG. 12B is a screenshot illustrating an example of a second view of the personalized content feed interface in accordance with certain implementations of the disclosed technology.

FIG. 12C is a screenshot illustrating an example of a third view of the personalized content feed interface in accordance with certain implementations of the disclosed technology.

FIG. 12D is a screenshot illustrating an example of a fourth view of the personalized content feed interface in accordance with certain implementations of the disclosed technology.

FIG. 13 illustrates a geographical example of a social needs initiative that is fulfilled by a global platform in accordance with certain implementations of the disclosed technology.

FIG. 14 is a block diagram illustrating an example of core requirements in accordance with certain implementations of the disclosed technology.

FIG. 15 is a block diagram that illustrates an example of a networked system in which embodiments of the disclosed technology may be implemented.

### DETAILED DESCRIPTION

Implementations of the disclosed technology are generally directed to a technology platform that is a productivity tool built to leverage the untapped potential of the Body of Christ. This platform may be used as the communication and mobilization infrastructure for the Great Commission by mobilizing the global Christian community to fulfill the Great Commission. Embodiments may seek to unify today's Great Commission supply chain, which generally includes: communication and mobilization; research, data, and intelligence; skills and human capital; parachurches and non-profit organizations; churches and ministries; missions organizations; academia and content; Christian marketplace movements; and Kingdom Capital and donors. Indeed, the disclosed platform may be specifically designed to solve the critical problems experienced by past efforts and also to be the technologically-driven resource that Christians need to collaboratively address significant economic, cultural, and spiritual issues in their cities and nations.

Among the many benefits that may result from a united supply chain are: intelligence that is empowered by human capital investment; codified learnings, best practices, and replicable plans; rapid, cross-silo communication; fully capitalized initiatives; aligned strategy, operations, and finance; and defined common finish lines. The platform may advantageously allow users to define the actual problems they want to solve and, as such, there are limitless use cases for this technology.

Implementations of the disclosed platform are unique among social media and crowdsourcing platforms. This accelerator technology can strategically connect and mobilize Christians to operate as a unified force. Using machine learning, artificial intelligence (AI), and neural networks, the disclosed platform, which may include a mobile application component, can be used to unify teams of Christians that are focused around passions, interests, causes, and spheres of influence.

Implementations of the disclosed crowdsourcing and problem solving technology can advantageously mobilize users to collaborate towards common finish lines. Using profile filters and proprietary algorithms, for example, implementations of the platform can provide people and organizations access to the team, time, talents and treasure needed to solve specific problems. Certain embodiments may include items pertaining to recruiting efforts, such as a listing of job postings, for example. The platform may proactively and automatically match one or more volunteers and/or paid candidates with potential jobs or other opportunities. Whether for a paid position, volunteer, or donor-funded position, organizations may be able to create a position profile and use the platform to be matched with qualified Kingdom-minded applicants by their profile filters. There may be API integrations with job performance profile tools and assessments.

Implementations of the disclosed technology may include a mobile application that is configured to use AI and neural networks to create unified teams of people, e.g., Christians, focused around passions, interests, causes and spheres of influence. This technology can advantageously leverage crowdsourcing and data analytics to mobilize people, e.g., Christians, around the world from for-profit, non-profit, and civic sectors. The mobile application can provide users with various abilities such as finding a team and/or forming a team, finding causes, initiatives, and issues, and accessing content, resources, and thought leadership.

In certain embodiments, a crowdsourced problem solving methodology may include defining a problem, crowdsourcing solutions, crowdsourcing action plans, and mobilizing people. The methodology may further include crowdsourcing funds, executing a plan, broadcasting stories, and codifying learnings. The methodology may ultimately include replicating a blueprint, particularly when such blueprint has demonstrated a certain level of success.

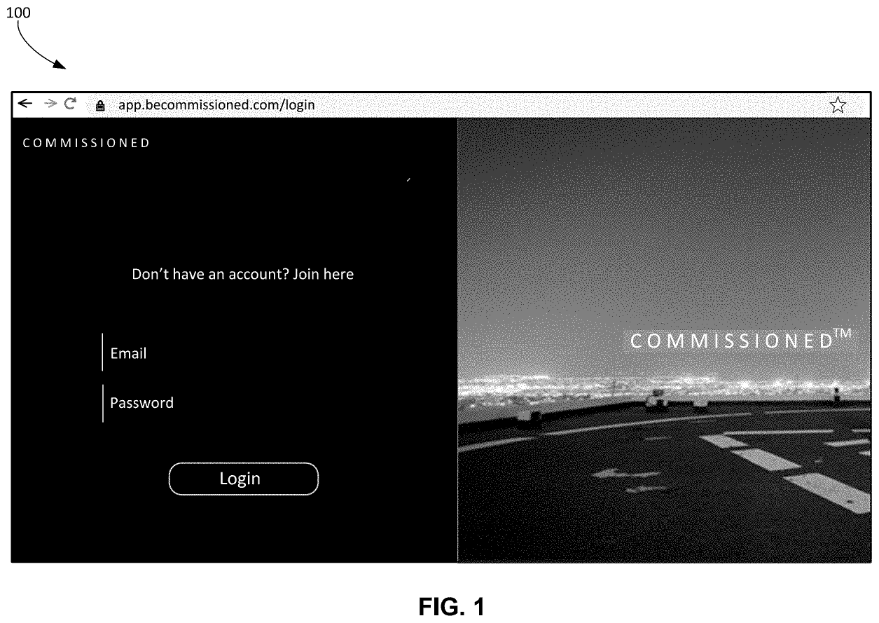

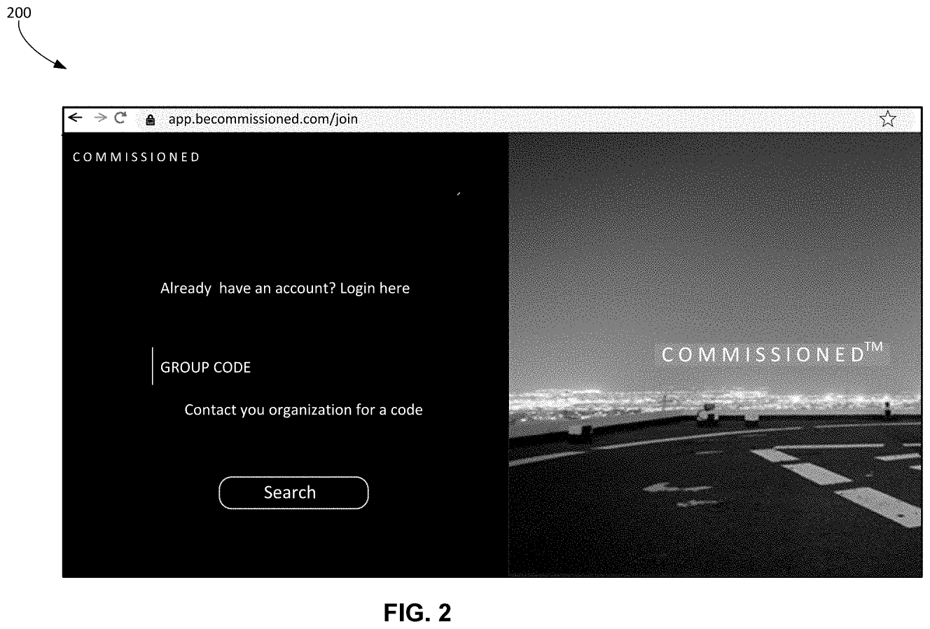

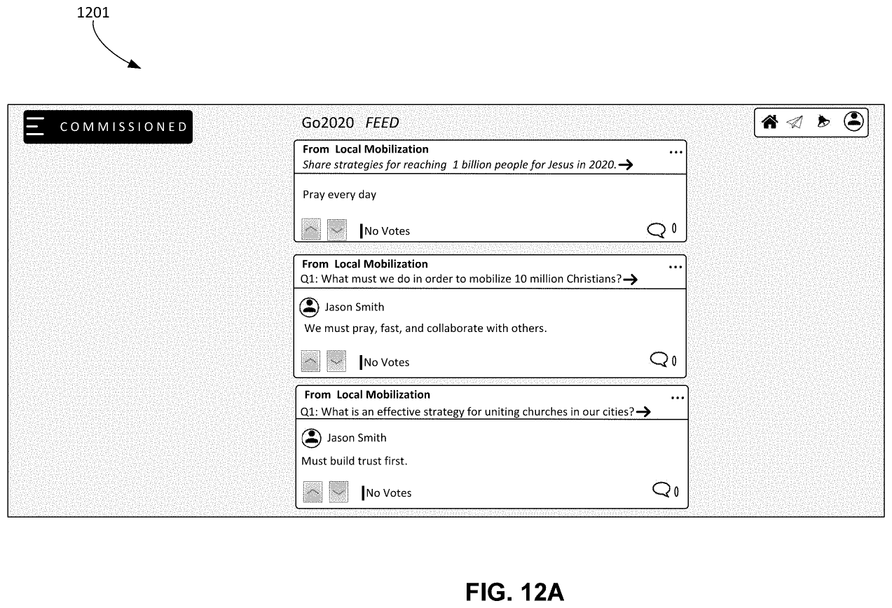

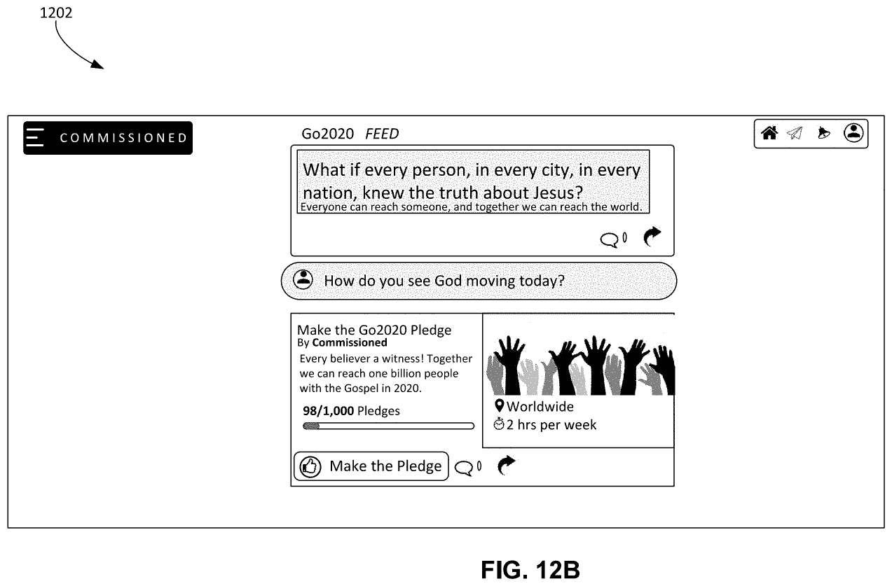

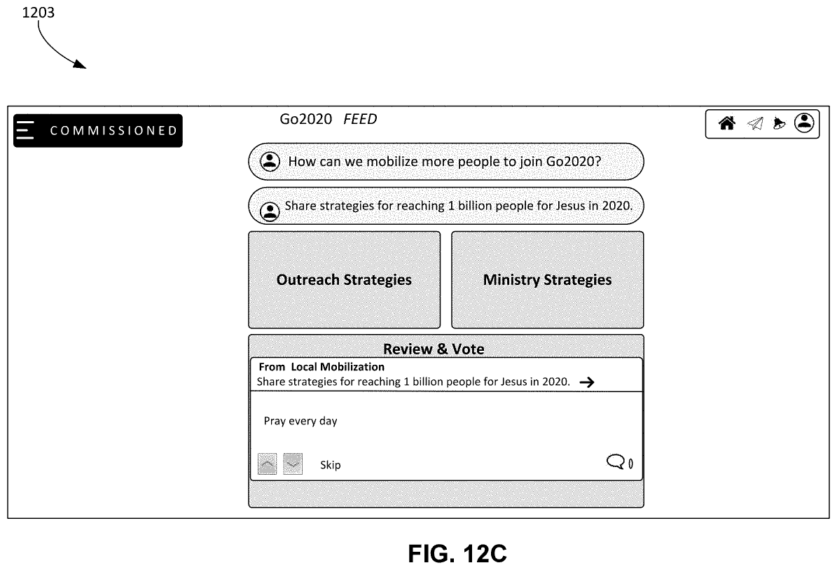

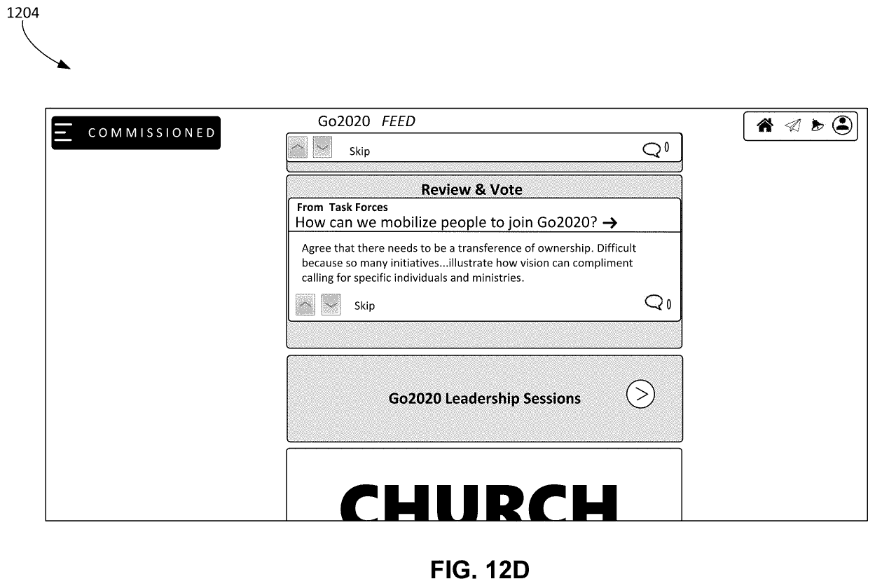

FIG. 1 is a screenshot 100 illustrating an example of a register/login interface in accordance with certain implementations of the disclosed technology. In the example, the interface presents the user with two options: create a new account (using a “Join here” feature) or, if the user has already created an account, log into the platform using his or her credentials, e.g., email address and password. Once the user enters the proper email address and password combination and presses a “Login” button (or equivalent feature), the platform can present the user with a personalized content feed interface such as that illustrated by FIG. 12. If the user selects the “Join here” feature, however, the platform can present to the user a group code entry interface such as that illustrated by FIG. 2.

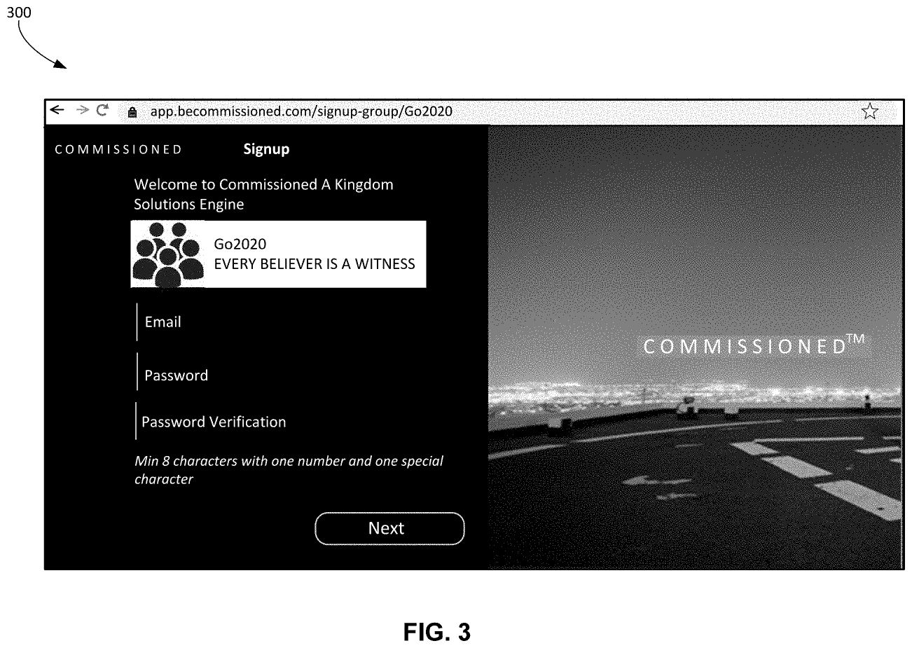

FIG. 2 is a screenshot 200 illustrating an example of a group code entry interface in accordance with certain implementations of the disclosed technology. In the example, the interface presents the user with two options: enter a Group Code or, if the user has already created an account, log into the platform directly. The user can enter a Group Code provided to him by a certain organization that he or she wants to be involved with, for example. Once the user enters the Group Code and presses a “Search” button (or equivalent feature), the platform can present to the user a list of search results. In situations where there is only one match or a strong match, the platform can automatically populate the identified group. Once the user selects a group, the platform can present to the user an email address and password entry interface such as that illustrated by FIG. 3.

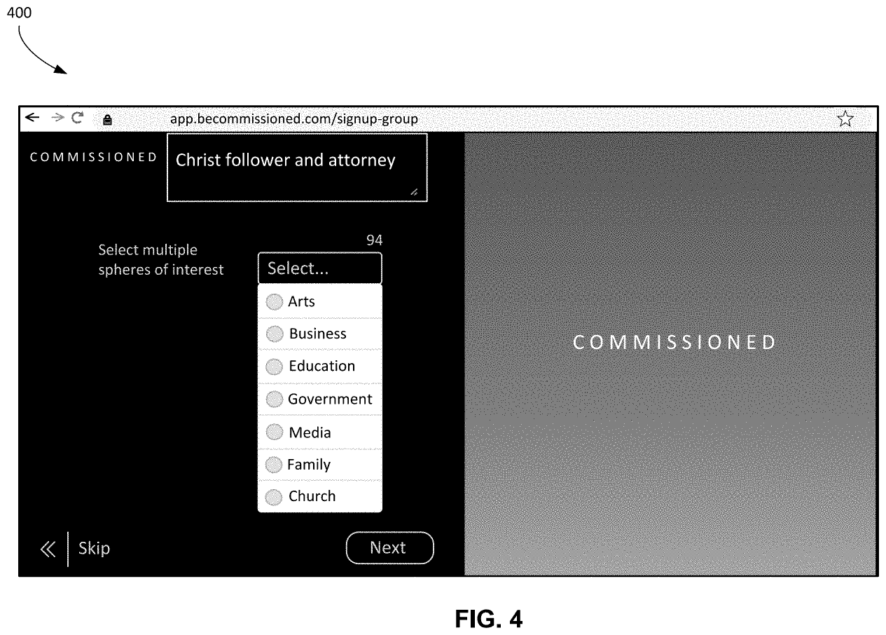

FIG. 3 is a screenshot 300 illustrating an example of an email address and password entry interface in accordance with certain implementations of the disclosed technology. In the example, the interface presents the user with fields for the user to enter his or her email address and desired password. The interface also requires the user to re-enter the password for verification purposes. Once the user enters this information and presses a “Next” button (or equivalent feature), the platform can present to the user a sphere of interest entry interface such as that illustrated by FIG. 4.

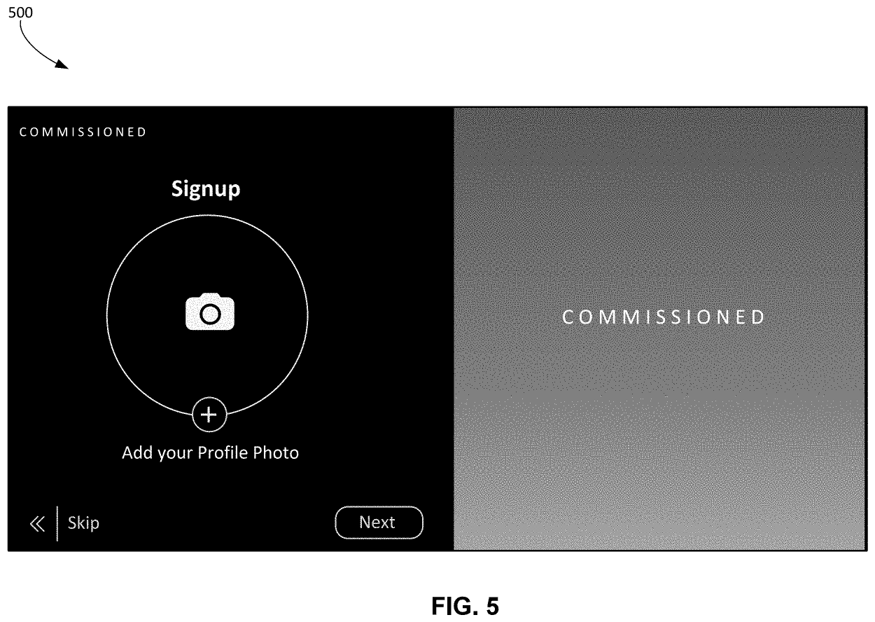

FIG. 4 is a screenshot 400 illustrating an example of a sphere of interest entry interface in accordance with certain implementations of the disclosed technology. In the example, the interface presents the user with a list of various spheres of interest. The user can select one or more spheres of interest that may be pertinent to him or her such as, for example, Arts, Business, Education, Government, Media, Family, and Church. Once the user has finished selecting the pertinent spheres and presses a “Next” button (or equivalent feature), the platform can present to the user a user photo interface such as that illustrated by FIG. 5.

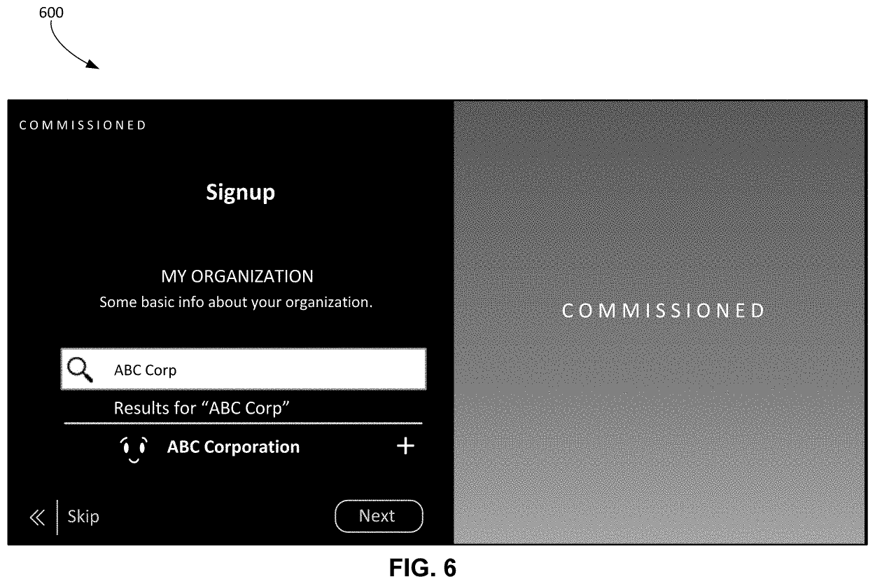

FIG. 5 is a screenshot 500 illustrating an example of a user photo interface in accordance with certain implementations of the disclosed technology. In the example, the interface provides the user with an ability to take or otherwise add a photo of himself or herself to be associated with his or her profile. Once the user enters a photo and presses a “Next” button (or equivalent feature), the platform can present to the user an organization selection interface such as that illustrated by FIG. 6.

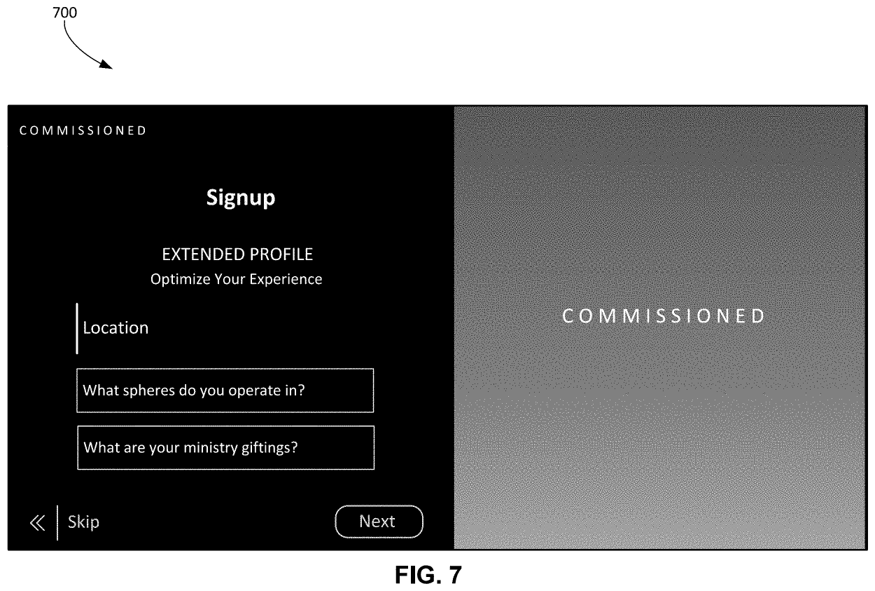

FIG. 6 is a screenshot 600 illustrating an example of an organization selection interface in accordance with certain implementations of the disclosed technology. In the example, the interface presents the user with a field in which the user may type or start to type the name of an organization such as, for example, the user's employer. If the platform already has a stored record corresponding to the organization, the platform can automatically present a listing for the organization to the user. Once the user selects the organization and presses a “Next” button (or equivalent feature), the platform can present to the user an extended profile entry interface such as that illustrated by FIG. 7.

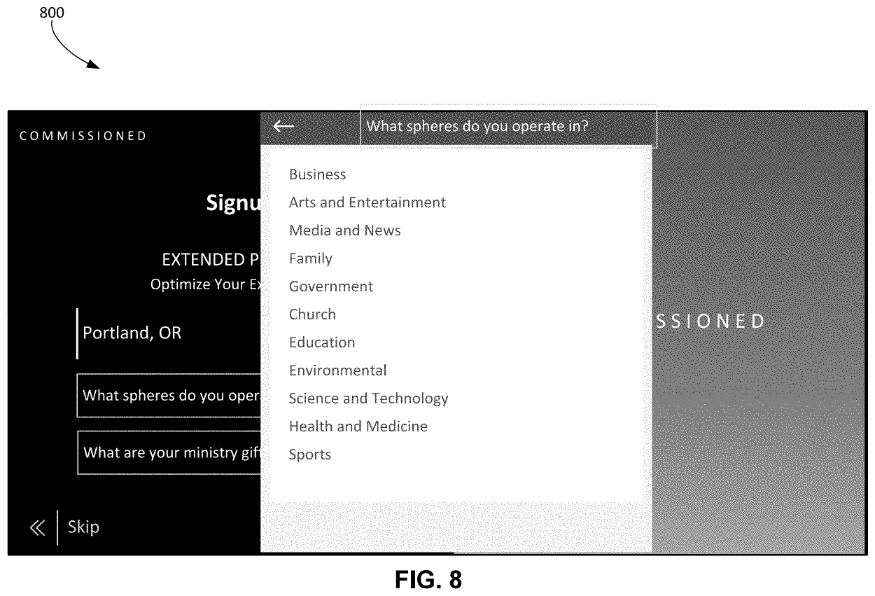

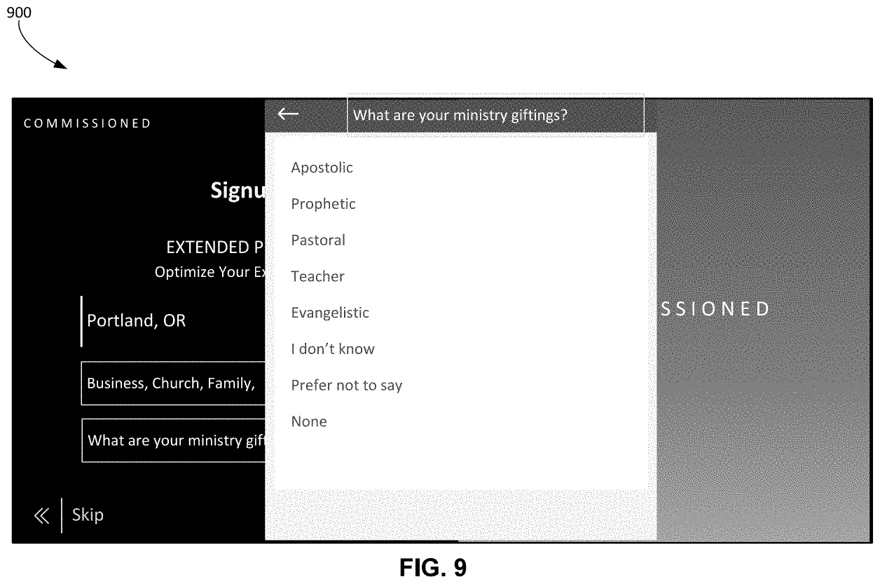

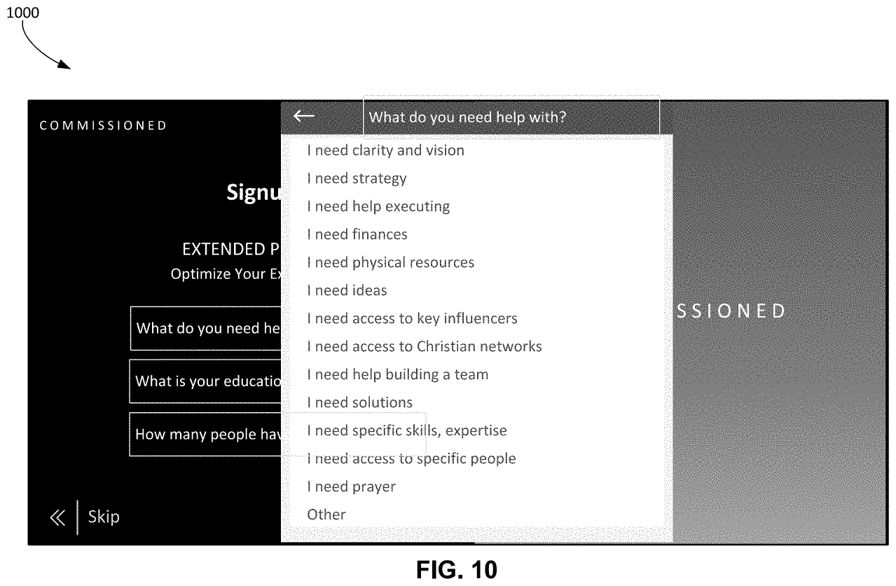

FIG. 7 is a screenshot 700 illustrating an example of a first extended profile entry interface in accordance with certain implementations of the disclosed technology. In the example, the interface presents the user with an opportunity to enter information pertaining to three areas: geographic location, spheres, and ministry giftings. Clicking on the sphere field can cause the platform to present the user with a sphere identification interface such as that illustrated by FIG. 8. Clicking on the ministry giftings field can cause the platform to present the user with a ministry giftings identification interface such as that illustrated by FIG. 9. Once the user has completed entering this information and presses a “Next” button (or equivalent feature), the platform can present to the user a second extended profile entry interface such as that illustrated by FIG. 10.

FIG. 8 is a screenshot 800 illustrating an example of a sphere identification interface in accordance with certain implementations of the disclosed technology. In the example, the interface presents the user with a list of various spheres in which the user may operate. The user can select one or more spheres in which he or she operates such as, for example, Business, Arts and Entertainment, Media and the News, Family, Government, Church, Education, Environmental, Science and Technology, Health and Medicine, and Sports.

FIG. 9 is a screenshot 900 illustrating an example of a ministry giftings identification interface in accordance with certain implementations of the disclosed technology. In the example, the interface presents the user with a list of various ministry giftings that he or she may have. The user can select one or more ministry giftings such as, for example, Apostolic, Prophetic, Pastoral, Teacher, and Evangelistic. The interface may also present the user with three alternative answers: “I don't know,” “Prefer not to say,” and “None.”

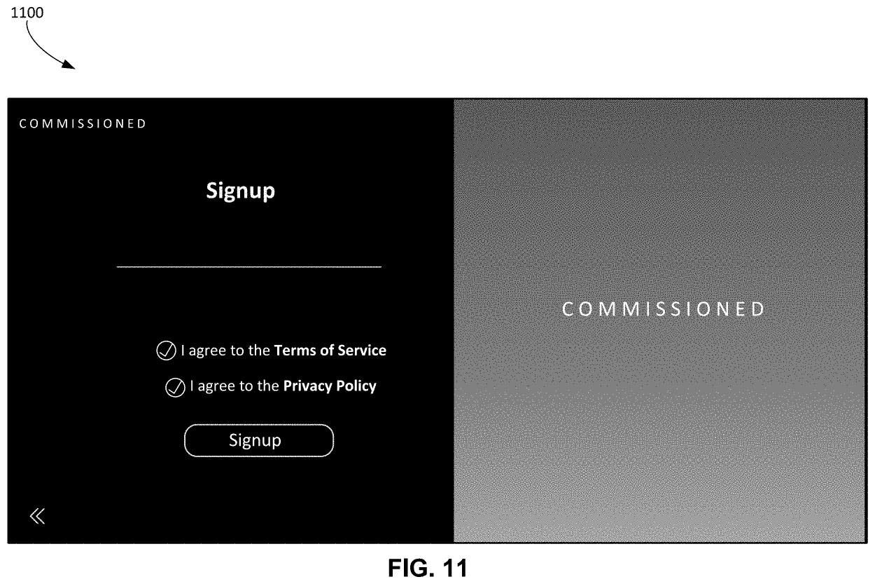

FIG. 10 is a screenshot 1000 illustrating an example of a second extended profile entry interface in accordance with certain implementations of the disclosed technology. In the example, the interface may provide the user with an opportunity to enter additional information that the platform may use in crowdsourcing and crowdfunding efforts. For example, the interface may allow the user to enter one or more areas of help that the user is seeking. The interface may also allow the user to enter his or her educational background and/or other information. Once the user enters the requested information and presses a “Next” button (or equivalent feature), the platform can present to the user a signup confirmation interface such as that illustrated by FIG. 11.

It will be appreciated that implementations of the disclosed platform may allow the user to enter various alternative and/or additional types of information pertaining to the user such as, for example, links to one or more social media accounts may have, e.g., Facebook, Twitter, LinkedIn, and Instagram.

FIG. 11 is a screenshot 1100 illustrating an example of a signup confirmation interface in accordance with certain implementations of the disclosed technology. In the example, the interface requires the user to confirm agreement of acceptance of the Terms of Service and Privacy Policy. Once the user enters this information and presses a “Signup” button (or equivalent feature), the platform can present to the user a personalized content feed interface such as that illustrated by FIG. 12.

FIG. 12A is a screenshot 1201 illustrating an example of a first view of a personalized content feed interface in accordance with certain implementations of the disclosed technology. A personalized content feed may be essentially a modern day Gutenberg Press for the Body of Christ with thought leadership, intelligence, and mobilizing resources. In the example, the interface provides the user with a wealth of information and options such as messages, questions, and opportunities posted by other users of the platform. Each posting can have one or more additional features such as the ability for other users to comment on or otherwise react to the posting, for example.

FIG. 12B is a screenshot 1202 illustrating an example of a second view of the personalized content feed interface resulting from the user scrolling down from the first view of the personalized content feed interface illustrated by FIG. 12A. In the example, the personalized content feed includes a pledge interface configured to allow other users to make a specified pledge. The interface provides other features such as the ability for a user to forward the pledge to one or more other users of the platform.

FIG. 12C is a screenshot 1203 illustrating an example of a third view of the personalized content feed interface resulting from the user further scrolling down from the second view of the personalized content feed interface illustrated by FIG. 12B. In the example, the feed includes options for the user to select and view various strategies, e.g., outreach strategies and ministry strategies. The interface provides other options such as the ability for users to vote on one or more of the posted strategies.

FIG. 12D is a screenshot 1204 illustrating an example of a fourth view of the personalized content feed interface resulting from the user further scrolling down from the third view of the personalized content feed interface illustrated by FIG. 12C. In the example, the interface provides the user with a link to a listing of one or more leadership sessions that may be of interest to the user. The platform may select the sessions in the listing based on one or more pieces of information or attributes that are specific to the user, for example. In certain embodiments, the feed may provide information pertaining to conferences and events, e.g., a Kingdom master event calendar for speakers, sponsors, and attendees.

It will be appreciated that the various features presented by the different views of the personalized content feed interface illustrated by FIGS. 12A-12D are merely exemplary and not exhaustive. Indeed, the types and numbers of features that may be presented by the personalized content feed interface are virtually limitless and may be updated by the platform on a regular and/or contact basis.

It will be further appreciated that any or all of the interfaces illustrated by FIGS. 1-12 may be presented to a user by way of a web browser, e.g., on a laptop, desktop, tablet, or other suitable computing device, and/or a mobile application, e.g., using a smartphone, tablet, or other suitable mobile computing device.

In certain embodiments, each member user gets their own aggregated content feed based on their original profile and filters. Content can come from magazine contributors, apostolic leaders, speakers, authors, marketplace leaders, prophetic and church leaders, as well as platform users, for example. Content may be curated and moderated by administrators. Platform content may include a news feed, podcasts, prophetic words, thought leadership, stories, equipping resources, testimonies, information, events, courses, curriculum, books, articles, contributor content, and curated user-generated content, for example.

Certain embodiments may provide the ability to filter by Spheres: business, arts and entertainment, government, education, family, media, church, science and technology, and medical. Alternatively or in addition thereto there may be provided an ability to filter by Issues: abortion, human trafficking, economic recovery, hunger, clean water, health, marriages, city transformation, and discipling of nations. Alternatively or in addition thereto there may be provided an ability to filter by Geography: cities, states, regions, nations. Alternatively or in addition thereto there may be provided an ability to filter by Five-Fold Gifting: apostle, prophet, pastor, evangelist, and teacher.

In certain embodiments, social learning features may include leaderboards, gamification, and group incentives. A Learning Management System (LMS) may be used to allow users to easily take various types of courses and lessons that may align with the user's passions and interests.

In certain implementations, a crowdsourced solutions engine may be used to leverage the wisdom of the crowd to release various ideas, strategies, and solutions. Collaborative initiatives may be used to mobilize Christians to operate as a unified force in accomplishing God's purposes, for example. A “Find Your Tribe, Form a Tribe” feature can be used to allow users to join and collaborate with affinity groups of like-minded people. A volunteer management module may be used for meaningful collaboration and coordination between organizers and volunteers. Crowdfunding efforts may include free fundraising for certain causes and passions. Investing may also occur through equity crowdfunding.

Implementations may include the formation, editing, moderating, and potential deleting of one or more public groups and private groups. The platform may allow a user to create invite-only groups, for example. Alternatively or in addition thereto, the platform may allow the application to invite affinity-matched people to join. Group messaging may be used for secure, private, and direct communication with those in a user's groups and initiatives.

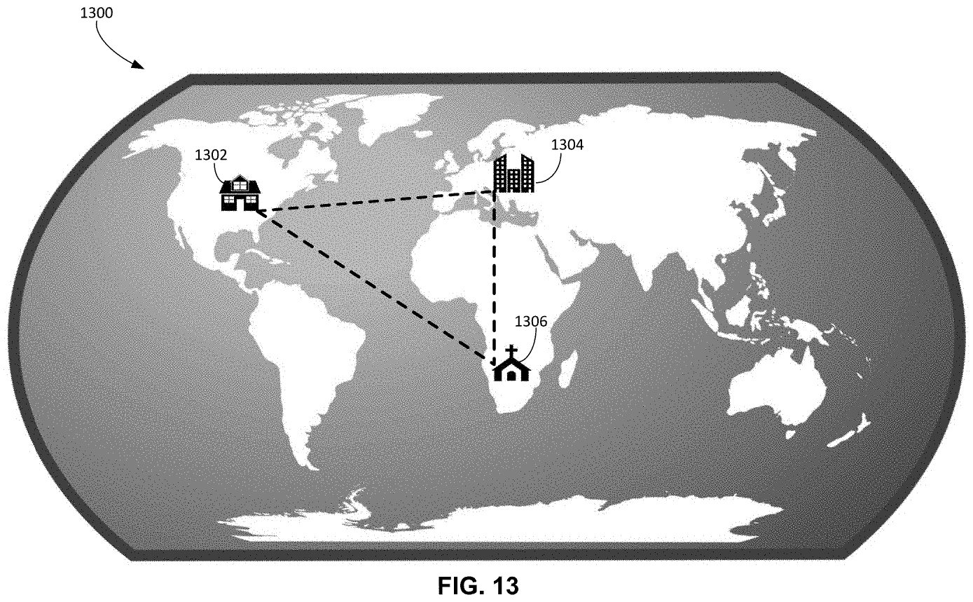

FIG. 13 illustrates a geographical example 1300 of a social needs initiative that is fulfilled by a global platform in accordance with certain implementations of the disclosed technology. In the example, the platform brings together a church 1306 in Africa in need of certain resources, a household 1302 in North America that is able and willing to provide monetary funds to the church 1306, and a company 1304 based in Europe that is able and willing to provide physical resources to the church 1306.

Some possible non-profit initiatives addressed by the disclosed platform could include solving homelessness, poverty, clean water, pro-life issues, church multiplication, orphans and foster kids, widow care, and human trafficking. Initiatives could also be directed to social justice issues or more overt Kingdom efforts such as missions, church planting, and Bible translation. Organizations could also use the disclosed platform to mobilize Christians to vote and participate in civic engagement at all levels of government, for example.

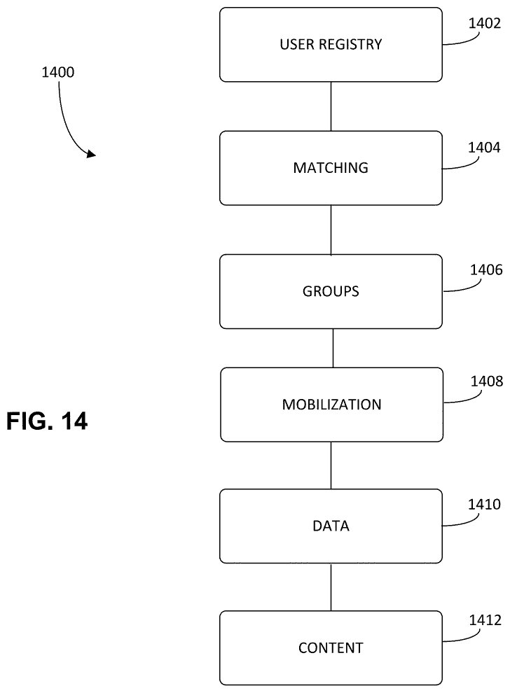

FIG. 14 is a block diagram illustrating an example 1400 of core modules in accordance with certain implementations of the disclosed technology. In the example, a user registry module 1402 may be configured to provide the ability for a user to create an account, login to the account, and fill out a profile. In certain embodiments, all users may be automatically added to a particular initiative as their Primary Initiative. Each user may fill out a profile that includes what spheres, issues, and geographies they're called to, what they have to offer, what they could use, and what type of connections they're looking for. All of this may be indexed and applied by algorithm to facilitate powerful Kingdom connections and “power teams” designed to execute strategies to influence culture.

A matching module 1404 may be used to match at least one user and/or group with at least one other user and/or group based at least in part on one or more of the following: city, state, and/or zip code; users'/groups' “haves”; users'/groups' “needs”; recommended people who are nearby; recommended neighborhood groups that are nearby. In certain embodiments, a goal may be to connect people with like-minded people to address specific issues in culture. Connections may be used to facilitate shared resources, create synergy, traction, and unified mobilization. Vision carriers can align with strategists, investors, administrators and operational teams.

In certain embodiments, the matching module 1404 may be able to identify other users that are geographically nearby using geofencing technology. For example, the matching module 1404 may use either or both a phone global positioning system (GPS) or laptop Internet Protocol (IP) address to pinpoint a user's geographic location and then locate other users/groups/events, etc. that are geographically near the user.

Tip sheets, guides, equipping resources, trainings, strategies, templates, worksheets, etc. may be created to help build strategic execution plans. Social ads, posters, apparel designs, yard signs, questionnaires, social posts, etc. can be uploaded to help accomplish these action plans. The platform may also provide the ability for members to self-select levels of involvement, facilitating contact with other tribe members. The amount of personal information shared may be determined by each individual, including the ability for users to communicate internally within the platform without disclosing personal information to the group.

A groups module 1406 may be configured to provide the ability for users to create a “neighborhood” group and a corresponding neighborhood group code. The module 1406 may further provide the ability for users who are members of the group to easily invite their neighbors and/or others to the group. The module 1406 may also provide users with the ability to share updates to social media, email, text, etc. In certain embodiments, users may be automatically added into “messaging group chats” by the platform based on each of the users' groups.

A mobilization module 1408 may be configured to provide users with the ability to publish a need to each of the user's Groups such as, for example, transportation; medical (e.g., doctor trips, medicine, and medical equipment); food; supplies; shelter; and wellness checks. The module may also be configured to provide a user with the ability to set a deadline by when the need(s) should or must be met. For example, the user may need to leave for a doctor appointment at noon, or a user may need someone to check on his or her grandmother for the next 10 days. The module 1408 may be further configured to provide a single common “wall” where all “needs” near the user may be listed (e.g., by zip code and city). The module 1408 may also be configured to provide users with the ability to search for “needs” and the ability to “pledge” to meet such needs. A Reporting sub-module may be configured to provide information as to how many needs are being met and/or which needs are still not met.

A data module 1410 may be configured to collect data. In certain embodiments, the data may be aggregated by zip code, city, state, needs, and pledges. The data may be displayed visually, e.g., on a map. In certain implementations, a content module 1412 may be configured to obtain content from any or all of a user's groups, initiatives, and connections.

Certain implementations of the disclosed technology are directed to a centralized infrastructure and backbone that aligns all the spheres of users together, while also connecting to other hubs outside of the platform. Use cases, features and functionality of the platform may include, but are not limited to, the following: unify, mobilize and influence the Body of Christ; inspire, cast vision, spread hope; come alongside, partner with and join together isolated Christians; build coalitions of coalitions and networks of networks; motivate and encourage; resourcing the Kingdom; articulating God's vision for each sphere; what is God doing in each sphere?; what is God saying in each sphere?; who is doing what?; who has previous done things successfully?; a sustained pattern of public persuasion to influence culture; networking the Army of God; mobilize a movement of the people of God; unity and collaboration; and community.

In certain embodiments, the disclosed platform represents an online place where people can gather with other like-minded people (e.g., similar spheres, issues, geographies, giftings) through meetups (e.g., both online and offline) as well as access to events, news feeds, notifications, content, resources and a repository of best practices shared and transferred between spheres. In certain embodiments, the disclosed platform may include a fully developed broadcast channel that is or can be integrated into social media platforms and syndicated feeds.

The disclosed platform may provide users with the ability to post both public and private events. Administrators or other authorized users may be able to see every digital event going on, review the history and analytics, communicate with the participants, join the event, and offer ads and resources to event attendees, for example. There may also be a Master Kingdom Event Calendar such that people can see what events are happening around the globe that may pertain to their own Kingdom assignments (e.g., by sphere, cause, passion, and/or interest).

The disclosed platform may identify people who are active in local geographical areas by spheres, issues, organizations (e.g., church, business, non-profit, and ministry). The platform may notify other members when a new match is made, either one to one or one to many. Administrators may be able to run reports to inform strategic planning, messaging and the entire seven mountain movement. A map may be used to allow people and organizations to create local Groups to unify for city transformation.

The platform may allow people and organizations to create their own private circles to invite their own contacts into those spaces. There may also be direct messaging within the application and video conferencing, along with a repository for notes, strategic plans, and whiteboard sessions, for example. Certain embodiments may include the ability to tag content and resources from the platform and have them easily accessible within these private circles.

In certain implementations, the disclosed platform may use a “freemium” model, whereby users may be able to pay a monthly subscription fee to access original content as well as advanced features and functionality. The distributed ledger can provide enhanced data and analytics. Certain embodiments may include the implementation of blockchain protocols.

The platform can also offer powerful B2B and B2C advertising platforms whereby various brands and organizations may direct advertisements and sponsored content targeted to specific groups of people, for example. Additional revenue streams may include, but are not limited to, e-commerce, licensing, custom analytic reports, data queries, event postings, job postings, equity crowdfunding, and enterprise agreements.

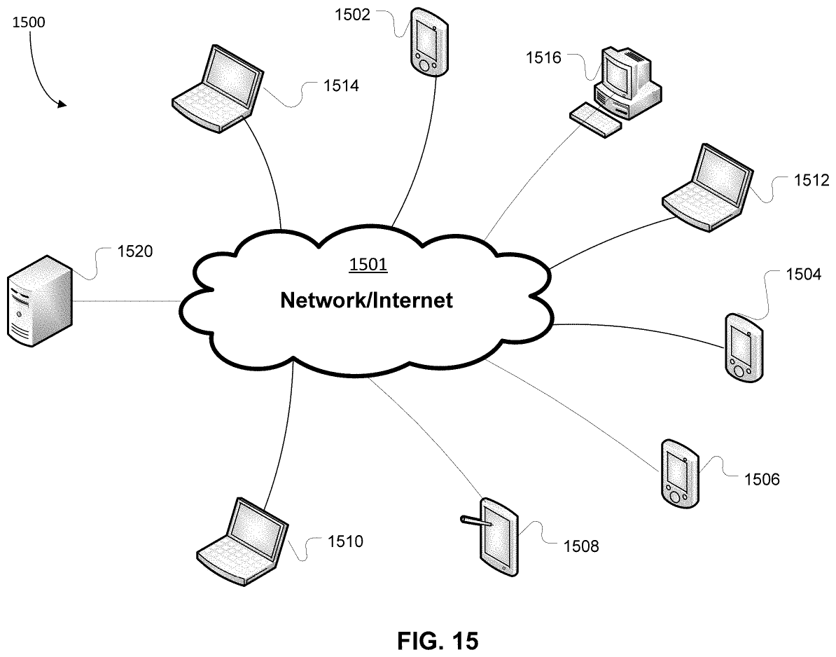

FIG. 15 is a block diagram that illustrates an example of a networked system 1500 in which embodiments of the disclosed technology may be implemented. In the example, the system 1500 includes a network 1501, e.g., the Internet, through which multiple devices can communicate. Such devices may include smartphones 1502, 1504, and 1506, such as Apple® iPhones or Samsung® Android phones, for example, a tablet 1508, such as an Apple® iPad, laptop computers 1510, 1512, and 1514, and a desktop computer 1516. In the example, the system 1500 also includes a server 1520 that may be configured to provide data processing and/or storage capabilities.

It will be appreciated that certain embodiments or portions of the disclosed technology may be implemented as either or both Software as a Service (SaaS) or as a Platform as a Service (PaaS).

The following discussion is intended to provide a brief, general description of a suitable machine in which certain embodiments of the disclosed technology or portions thereof can be implemented. As used herein, the term “machine” is intended to broadly encompass a single machine or a system of communicatively coupled machines or devices operating together. Exemplary machines may include computing devices such as personal computers, workstations, servers, portable computers, handheld devices, tablet devices, and the like.

Typically, a machine includes a system bus to which processors, memory such as random access memory (RAM), read-only memory (ROM), and other state-preserving medium, storage devices, a video interface, and input/output interface ports can be attached. The machine may also include embedded controllers such as programmable or non-programmable logic devices or arrays, Application Specific Integrated Circuits (ASICs), embedded computers, smart cards, and the like. The machine may be controlled, at least in part, by input from conventional input devices such as keyboards and mice, as well as by directives received from another machine, interaction with a virtual reality (VR) environment, biometric feedback, or other pertinent input.

The machine may utilize one or more connections to one or more remote machines, such as through a network interface, modem, or other communicative coupling. Machines can be interconnected by way of a physical and/or logical network, such as an intranet, the Internet, local area networks, wide area networks, etc. One having ordinary skill in the art will appreciate that network communication may utilize various wired and/or wireless short range or long range carriers and protocols, including radio frequency (RF), satellite, microwave, Institute of Electrical and Electronics Engineers (IEEE) 545.11, Bluetooth, optical, infrared, cable, laser, etc.

Embodiments of the disclosed technology may be described by reference to or in conjunction with associated data including functions, procedures, data structures, application programs, instructions, etc. that, when accessed by a machine, may result in the machine performing tasks or defining abstract data types or low-level hardware contexts. Associated data may be stored in, for example, volatile and/or non-volatile memory, such as RAM and ROM, or in other storage devices and their associated storage media, which can include hard-drives, floppy-disks, optical storage, tapes, flash memory, memory sticks, digital video disks, biological storage, and other non-transitory, physical storage media.

Associated data may be delivered over transmission environments, including the physical and/or logical network, in the form of packets, serial data, parallel data, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

We claim:

1. A crowdsourcing platform, comprising:
a user registry module configured to allow each of a plurality of users to create an account with the platform, the account including information pertaining to either or both at least one identified resource and at least one identified need;
a group module configured to allow at least one of the plurality of users to create at least one group and a corresponding group code;
a matching module configured to match at least one of the plurality of users with one of the at least one group based at least in part on an identified resource of a user and an identified need of a user; and
a mobilization module configured to allow each matched user to publish the identified need to each of the matched user's groups.

2. The crowdsourcing platform of claim 1, further comprising a data module configured to collect data pertaining to the published need and aggregate the collected data by at least one parameter.

3. The crowdsourcing platform of claim 1, further comprising a content module configured to obtain content from at least one of the matched user's groups.

4. The crowdsourcing platform of claim 3, wherein the content module is configured to obtain content from at least one selected from the following group: magazine contributors, apostolic leaders, speakers, authors, marketplace leaders, prophetic and church leaders, and other platform users.

5. The crowdsourcing platform of claim 1, wherein the user registry module is configured to allow a user to create the user's account by receiving from the user information pertaining to at least one selected from the following group: email address, password, group code, spheres, and ministry giftings.

6. The crowdsourcing platform of claim 5, wherein the spheres include at least one selected from the following group: Business, Arts and Entertainment, Media and the News, Family, Government, Church, Education, Environmental, Science and Technology, Health and Medicine, and Sports.

7. The crowdsourcing platform of claim 5, wherein the ministry giftings include at least one selected from the following group: Apostolic, Prophetic, Pastoral, Teacher, and Evangelistic.

8. The crowdsourcing platform of claim 3, wherein the content module is further configured to provide a personalized content feed to each user.

9. The crowdsourcing platform of claim 8, wherein the personalized content feed includes at least one selected from the following group: a news feed, podcasts, prophetic words, thought leadership, stories, equipping resources, testimonies, information, events, courses, curriculum, books, articles, contributor content, and curated user-generated content.

10. The crowdsourcing platform of claim 8, wherein the personalized content feed includes a pledge interface configured to allow users to make a specified pledge.

11. The crowdsourcing platform of claim 10, wherein the pledge interface is further configured allow users to forward the pledge to one or more other users of the platform.

12. A computer-implemented method, comprising:
a user registry module allowing each of a plurality of users to create an account with the platform, the account including information pertaining to either or both at least one identified resource and at least one identified need;
a group module allowing at least one of the plurality of users to create at least one group and a corresponding group code;
a matching module matching at least one of the plurality of users with one of the at least one group based at least in part on an identified resource of a user and an identified need of a user; and
a mobilization module allowing each matched user to publish the identified need to each of the matched user's groups.

13. The computer-implemented method of claim 12, further comprising a data module collecting data pertaining to the published need and aggregating the collected data by at least one parameter.

14. The computer-implemented method of claim 12, further comprising a content module obtaining content from at least one of the matched user's groups.

15. The computer-implemented method of claim 12, further comprising the user registry module allowing the user to create the user's account by receiving from the user information pertaining to at least one selected from the following group: email address, password, group code, spheres, and ministry giftings.

16. The computer-implemented method of claim 15, wherein the spheres include at least one selected from the following group: Business, Arts and Entertainment, Media and the News, Family, Government, Church, Education, Environmental, Science and Technology, Health and Medicine, and Sports.

17. The computer-implemented method of claim 15, wherein the ministry giftings include at least one selected from the following group: Apostolic, Prophetic, Pastoral, Teacher, and Evangelistic.

18. The computer-implemented method of claim 14, further comprising the content module providing a personalized content feed to each user.

19. The computer-implemented method of claim 18, wherein the personalized content feed includes a pledge interface allowing users to make a specified pledge and optionally forward the pledge to one or more other users of the platform.

20. One or more tangible, non-transitory computer-readable media storing instructions that, when executed by a processor, cause the processor to perform the computer-implemented method of claim 12.
